(19) United States
(12) Patent Application Publication
(10) Pub. No.: US 2005/0078062 A1
(43) Pub. Date: Apr. 14, 2005

(54) Method and apparatus of driving a plasma display panel

(75) Inventors: Sang Jin Yoon, Ubang Shincheonji Town (KR); Seong Ho Kang, Buk-gu (KR)

Correspondence Address: FLESHNER & KIM, LLP, P.O. BOX 221200, CHANTILLY, VA, 20153, US

(73) Assignee: LG Electronics Inc.

(21) Appl. No.: 10/947,334

(22) Filed: Sep. 23, 2004

(30) Foreign Application Priority Data
Sep. 27, 2003 (KR) 10-2003-0067170

(51) Int. Cl. G09G 3/28

(52) U.S. Cl. 345/63

(57) ABSTRACT

The present invention relates to a method for driving a plasma display panel in which a sustain driving margin can be improved. According to an embodiment of the present invention, the method for driving the plasma display panel includes the steps of setting the number of a sustain pulse corresponding to an average picture level (APL), and setting the period of a sustain pulse in proportion to the average picture level.

### BACKGROUND OF THE INVENTION

### CROSS-REFERENCES TO RELATED APPLICATIONS

This Nonprovisional application claims priority under 35 U.S.C. § 119(a) on Patent Application No. 10-2003-0067170 filed in Korea on Sep. 27, 2003, the entire contents of which are hereby incorporated by reference.

1. Field of the Invention

The present invention relates to a method for driving a plasma display panel and apparatus thereof, and more particularly, to a method for driving a plasma display panel in which a sustain driving margin can be improved and apparatus thereof.

2. Background of the Related Art

A plasma display panel (hereinafter, referred to as ‘PDP’) is a display device using that a visible ray is generated from phosphors when the phosphors are excited by a vacuum ultraviolet ray generated upon discharge of a gas. The PDP has advantages that it is thin in thickness and light in weight and can be made large with high definition compared to a cathode ray tube (CRT) that is the greater part of the display means. The PDP consists of a number of discharge cells arranged in a matrix shape and one of the discharge cells constitutes one pixel.

FIG. 1 is a perspective view illustrating the structure of a discharge cell of a conventional three-electrode AC surface discharge type PDP.

Referring to FIG. 1, the discharge cell of the conventional three-electrode AC surface discharge type PDP includes a first electrode 12Y and a second electrode 12Z both of which are formed in parallel on an upper substrate 10, and an address electrode 20X formed on a lower substrate 18.

An upper dielectric layer 14 and a protection film 16 are stacked on the upper substrate 10 on which the first electrode 12Y and the second electrode 12Z are formed. A wall charge generated upon plasma discharge is accumulated on the upper dielectric layer 14. The protection film 16 serves to prevent the upper dielectric layer 14 from being damaged due to sputtering generated upon plasma discharge and also to increase emission efficiency of secondary electrons. The protection film 16 is formed using typically magnesium oxide (MgO).

A lower dielectric layer 22 and barrier ribs 24 are formed on the lower substrate 18 on which the address electrode 20X is formed. A phosphor layer 26 is coated on the lower dielectric layer 22 and the barrier ribs 24. The address electrode 20X is formed in the direction to cross the first electrode 12Y and the second electrode 12Z.

The barrier ribs 24 are formed in parallel to the address electrode 20X and serve to prevent ultraviolet rays and a visible ray generated by a discharge from leaking toward neighboring discharge cells. The phosphor layer 26 is excited by ultraviolet rays generated upon plasma discharge to generate one of red, green and blue visible rays. An inert gas for a gas discharge is injected into discharge spaces formed between the upper substrate 10 and the barrier ribs 24 and between the lower substrate 1 8 and the barrier ribs 24.

Such a PDP is driven by dividing one frame into several sub fields having different discharge numbers in order to represent the gray level of a picture. Each of the sub fields is divided into a reset period for generating a discharge evenly, an address period for selecting a discharge cell, and a sustain period that represents the gray level depending on the discharge number.

For example, if a picture is to be represented using 256 gray levels, a frame period (16.67 ms) corresponding to 1/60 second is divided into eight sub fields SF1 to SF8, as shown in FIG. 2. Also, each of the 8 sub fields SF1 to SF8 is divided into an address period and a sustain period. In the above, the reset period and the address period of each of the sub fields are the same every sub fields, whereas the sustain period of each of the sub fields increases in the ratio of 2n (n=0,1,2,3,4,5,6,7) in each of the sub fields, thus representing a picture depending on a gray level.

FIG. 3 is a block diagram illustrating the structure of an apparatus for driving the conventional plasma display panel.

Referring to FIG. 3, the apparatus for driving the conventional PDP includes a first inverse gamma correction unit 32A, a gain control unit 34, an error diffusion unit 36, a sub field mapping unit 38 and a data alignment unit 40 all of which are connected between an input line 1 and a panel 46; and a frame memory 30, a second inverse gamma correction unit 32B, an average picture level (hereinafter, referred to as ‘APL’) unit 42 and a waveform generator 44 all of which are connected between the input line 1 and the panel 46.

The first and second inverse gamma correction units 32A and 32B serve to linearly convert a brightness value depending on a gray level value of a picture signal by performing inverse gamma correction for a gamma corrected video signal. The frame memory 30 stores data (R, G and B) for one frame and supplies the stored data to the second inverse gamma correction unit 32B.

The APL unit 42 generates an N (N is a natural number) stage signal for controlling the number of a sustain pulse using the video data corrected by the second inverse gamma correction unit 32B. The gain control unit 34 functions to amplify the video data corrected in the first inverse gamma correction unit 32A as much as an effective gain.

The error diffusion unit 36 controls the brightness value minutely by diffusing an error component of a cell to neighboring cells. The sub field mapping unit 38 reallocates the video data corrected in the error diffusion unit 36 by the sub field.

The data alignment unit 40 converts the video data received from the sub field mapping unit 38 in a way that is suitable for a resolution format of the panel 46, and then supplies the converted video data to an address driving integrated circuit (hereinafter, referred to as ‘IC’) of the panel 46.

The waveform generator 44 generates a timing control signal according to an N stage signal received from the APL unit 42 and provides the generated timing control signal to an address driving IC, a scan driving IC and a sustain driving IC of the panel 46.

In the apparatus for driving the conventional plasma display panel, the APL unit 42 keeps constant power consumption of the PDP and highlights a relatively bright portion when brightness of the whole picture is dark. For this, the APL stage is set so that it is in inverse proportion to the number of the sustain pulse, as shown in FIG. 4. In other words, if the APL stage is high, a small number of a sustain pulse is supplied. If the APL stage is low, a large number of a sustain pulse is supplied. If the APL stage is set to be in inverse proportion to the number of a sustain pulse, power consumed in the panel is kept constant by some degree and a relatively bright portion is highlighted when brightness of the whole picture is dark.

If the APL stage is set to be in inverse proportion to the number of a sustain pulse as such, however, there is a problem that a sustain period is not utilized sufficiently since a small number of a sustain pulse is supplied in a high APL stage. That is, as the sustain pulse is supplied during some of the sustain period in the high APL stage, a sustain driving margin is lowered. Therefore, in the conventional PDP, emission efficiency when the APL stage is high is lower than those when the APL stage is not high.

This will be described in detail as follows. As a small number of a sustain pulse is supplied in a high APL stage, the sustain pulse is supplied only during some of a sustain period that is allocated previously. Accordingly, in the high APL stage, a period where a discharge is not generated (hereinafter, referred to as ‘pause period’) among the sustain period widens. If the pause period widens as such, i.e., a time where the sustain pulse is supplied between a current sustain period and a next sustain period is set to be long, a sustain driving margin is lowered. For example, if the pause period widens, a sustain discharge is generated unstably because charged particles generated by a previous sustain discharge are consumed through recombination.

### SUMMARY OF THE INVENTION

Accordingly, an object of the present invention is to solve at least the problems and disadvantages of the background art.

According to an embodiment of the present invention, there is provided a method for driving a plasma display panel, including the steps of: setting the number of a sustain pulse corresponding to an average picture level (APL); and setting the period of a sustain pulse in proportion to the average picture level.

According to the present invention, there is provided a method for driving a plasma display panel, including the steps of: setting the number of a sustain pulse corresponding to an average picture level (APL); and setting a High width of a sustain pulse in proportion to the average picture level.

According to the present invention, there is provided a method for driving a plasma display panel, including the steps of: setting the number of a sustain pulse corresponding to an average picture level (APL); and setting a Low width of a sustain pulse in proportion to the average picture level.

According to the present invention, there is provided an apparatus for driving a plasma display panel, including: an average brightness level unit for setting an average picture level corresponding to video data; and a period setting unit for setting the period of a sustain pulse in proportion to the average picture level set in the average brightness level unit.

According to a method for driving a plasma display panel and apparatus thereof of the present invention, emission efficiency can be improved by supplying a sustain pulse that has a wide period as an APL stage becomes high. Furthermore, in the present invention, a large number of sustain pulses can be supplied in a low APL stage by setting a high minimum threshold frequency. Therefore, peak brightness of a panel can be improved. In addition, in the present invention, a stabilized sustain discharge can be generated by setting a maximum threshold frequency so that a constant sustain margin can be secured.

### BRIEF DESCRIPTION OF THE DRAWINGS

Further objects and advantages of the invention can be more fully understood from the following detailed description taken in conjunction with the accompanying drawings in which:

FIG. 1 is a perspective view illustrating the structure of a discharge cell of a conventional three-electrode AC surface discharge type plasma display panel;

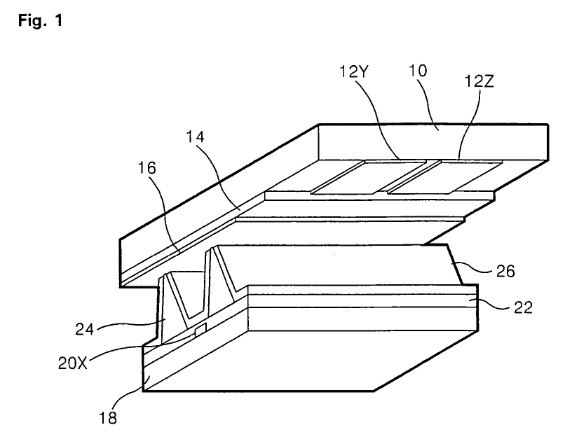

FIG. 2 shows one frame of the conventional three-electrode AC surface discharge type plasma display panel;

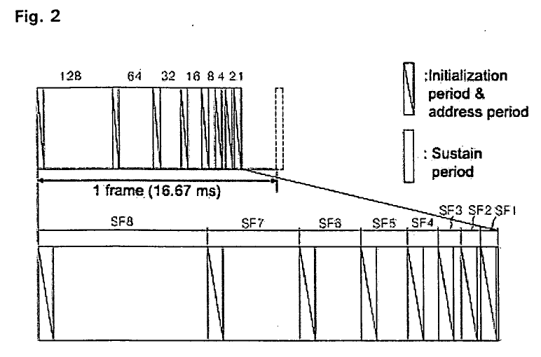

FIG. 3 is a block diagram illustrating the structure of an apparatus for driving the conventional plasma display panel;

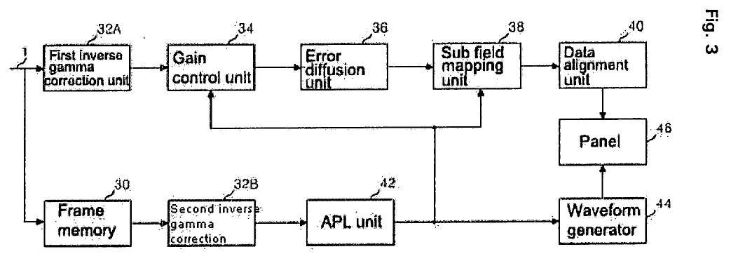

FIG. 4 is a graph illustrating the number of a sustain pulse that is set corresponding to an APL stage;

FIG. 5a and FIG. 5b are graphs illustrating the period of a sustain pulse depending on an APL stage according to a first embodiment of the present invention;

FIG. 6a and FIG. 6b are graphs illustrating that the High width of the sustain pulse widens in proportion to the APL as the period of the sustain pulse becomes wide;

FIG. 7a and FIG. 7b are graphs illustrating that the Low width of the sustain pulse widens in proportion to the APL as the period of the sustain pulse becomes wide;

FIG. 8a and FIG. 8b are graphs illustrating the period of a sustain pulse depending on an APL according to a second embodiment of the present invention;

FIG. 9a and FIG. 9b are graphs showing the period of a sustain pulse depending on an APL according to a third embodiment of the present invention;

FIG. 10a and FIG. 10b are graphs showing the frequency of a sustain pulse depending on an APL according to a fourth embodiment of the present invention;

FIG. 11 is a graph showing the frequency of a sustain pulse depending on an APL according to a fifth embodiment of the present invention;

FIG. 12 is a block diagram illustrating the structure of an apparatus for driving a plasma display panel according to an embodiment of the present invention; and

FIG. 13 is a block diagram illustrating the structure of an apparatus for driving a plasma display panel according to another embodiment of the present invention.

### DETAILED DESCRIPTION OF THE PREFERRED EMBODIMENT

The present invention will now be described in detail in connection with preferred embodiments with reference to the accompanying drawings in which like numerals refer to like elements.

### First Embodiment

According to an embodiment of the present invention, there is provided a method for driving a plasma display panel, including the steps of: setting the number of a sustain pulse corresponding to an, average picture level (APL); and setting the period of a sustain pulse in proportion to the average picture level.

In the step of setting the number of the sustain pulse, the number of the sustain pulse is set in inverse proportion to the average picture level.

The step of setting the period of the sustain pulse includes the step of setting a High width of the sustain pulse wide in proportion to the average picture level.

The step of setting the period of the sustain pulse includes the step of setting a Low width of the sustain pulse wide in proportion to the average picture level.

The step of setting the period of the sustain pulse includes the step of setting a Low width and a High width of the sustain pulse wide in proportion to the average picture level.

The greatest period of the sustain pulse is set 0.5 μs to 10 μs higher than the smallest period of the sustain pulse.

In at least some section of the average picture level, the period of the sustain pulse is changed.

The method further includes the step of setting a minimum threshold frequency over a predetermined average picture level stage so that the period of the sustain pulse is limited less than a predetermined width.

The minimum threshold frequency is set so that the greatest period of a sustain pulse that can be supplied widens within a range of 0.5 μs to 10 μs from the smallest period of the sustain pulse.

The method further includes the step of setting a maximum threshold frequency below a predetermined average picture level stage so that the period of the sustain pulse is limited over a predetermined width.

The period of the sustain pulse increases in a step shape as the period changes from a low stage of the average picture level to a high stage of the average picture level.

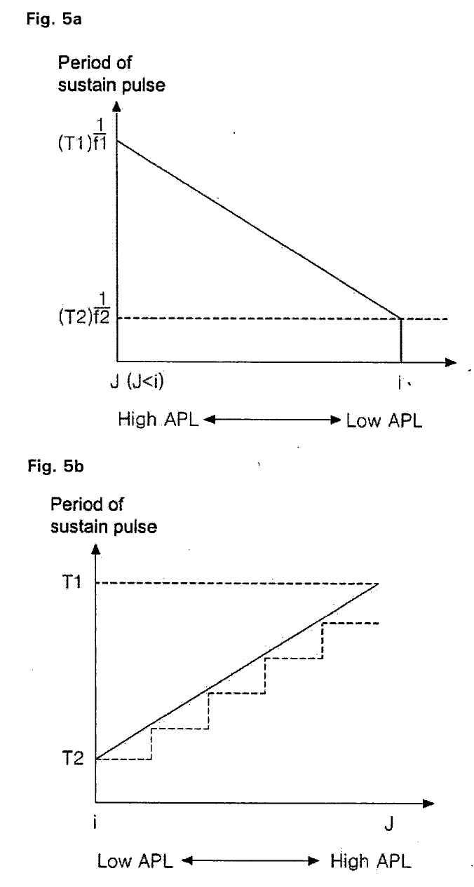

FIG. 5a and FIG. 5b are graphs illustrating the period of a sustain pulse depending on an APL stage according to a first embodiment of the present invention.

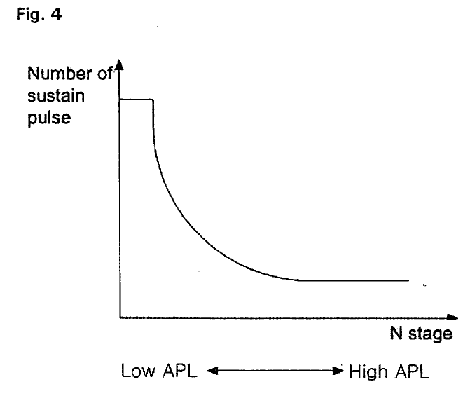

APL and the number of a sustain pulse have the inverse proportion relationship, as shown in FIG. 4. In other words, if the APL stage is high, a small number of sustain pulses is supplied to a panel. If the APL stage is low, a large number of sustain pulses is provided to the panel. At this time, in the present invention, the period of a sustain pulse is set in a way that increases linearly as the APL stage becomes higher (a frequency reduces linearly), as shown in FIG. 5a and FIG. 5b. (At this time, the number of a sustain pulse actually supplied is the same as the prior art.)

This will be described in detail as follows. In a low APL stage, an i (e.g. 1024) number of a sustain pulse is supplied to the panel. At this time, a frequency f2 of the sustain pulse supplied in the low APL stage is set to have a high value. Accordingly, a period T2 of the sustain pulse having the inverse proportion relationship with the frequency f2 has a narrow width, for example, the period of 5 μs. In other words, in the low APL stage, the i Number of the sustain pulse is supplied to the panel so that it has the period of T2.

Meanwhile, in a high APL stage, a J (e.g. 200) number of a sustain pulse is supplied to the panel. At this time, a frequency f1<f2 of the sustain pulse supplied in the high APL stage is set to have a low value. Therefore, the period T1 of the sustain pulse having the inverse proportion relationship with the frequency f1 has a wide width, for example, the period of 15 μs. That is, in the high APL stage, the J number of the sustain pulse is supplied to the panel so that it has the period of T1.

In other words, in the first embodiment of the present invention, the period of the sustain pulse increases so that it is proportional to the APL stage. If the period of the sustain pulse increases in proportion to the APL stage as such, the pause period does not widens even in the high APL stage. It is thus possible to improve the sustain driving margin.

Meanwhile, a period increase ratio that the period of the sustain pulse increases in proportion to the APL stage is decided experimentally. Practically, the period of the sustain pulse that increases in proportion to the APL stage can be set in various manners according to resolution, inch, etc. of a PDP. For instance, if a sustain pulse having the period of 5 μs is supplied in the lowest APL stage, a sustain pulse having the period of 5.5 μs to 15 μs can be provided in the highest APL stage. In other words, in the first embodiment of the present invention, the period of the sustain pulse can increase approximately 0.5 μs to 10 μs when the lowest APL stage changes to the highest APL stage.

Furthermore, in the present invention, the APL stage is divided into a number of section units. The period of the sustain pulse can be increased corresponding to the section units. In other words, in the present invention, as indicated by a dotted line of FIG. 5b, the APL stage can be divided into a number of sections, sustain pulses having the same period can be supplied in the APL stage included in the same section, and sustain pulses having different periods can be supplied in the APL stage included in other sections. In the above, the higher the APL stage included in the section, the greater the period of the sustain pulse is increased.

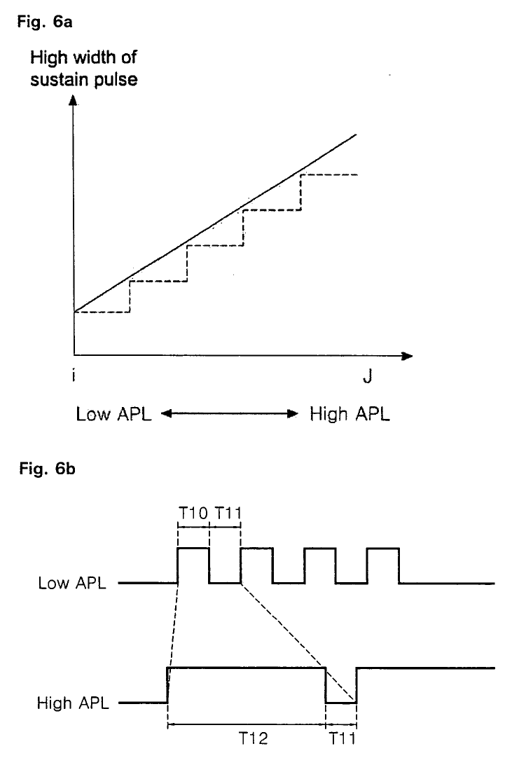

Meanwhile, in the present invention, in order to set the period of the sustain pulse wide, a variety of methods can be employed. For example, as shown in FIG. 6a and FIG. 6b, the period of the sustain pulse can be set to be wide by increasing only the High width in the sustain pulse.

In other words, as shown in FIG. 6a and FIG. 6b, the period of the sustain pulse can be set to be wide by increasing the High width of the sustain pulse as a low APL stage gradually changes to a high APL stage. If the High width of the sustain pulse widens as such, the sustain discharge can occur stably. In other words, if the High width of the sustain pulse widens, the time where the sustain discharge can occur becomes wide. Thus, probability that the sustain discharge can occur increases. Meanwhile, in the present invention, as indicated by a dotted line of FIG. 6a, the APL stage can be divided into a number of sections and the High width of the sustain pulse can increase corresponding to the sections. In other words, in the present invention, as indicated by the dotted line of FIG. 6a, the APL stage can be divided into a number of sections, sustain pulses having the same High width can be supplied in an APL stage included in the same section, and sustain pulses having different High widths can be supplied in an APL stage included in different sections.

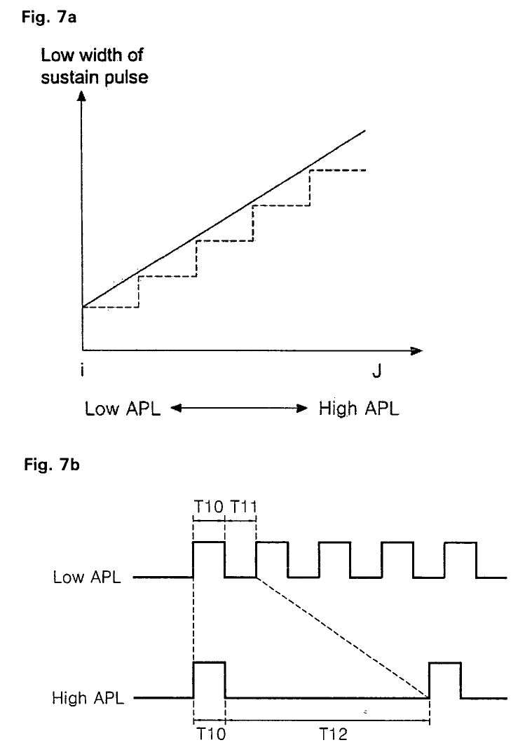

Furthermore, in the present invention, in order to set the period of the sustain pulse wide, only a Low width of the sustain pulse can be increased, as shown in FIG. 7a and FIG. 7b. That is, as shown in FIG. 7a and FIG. 7b, it is possible to set the period of the sustain pulse wide by increasing the Low width of the sustain pulse as a low APL stage gradually changes to a high APL stage. If the Low width of the sustain pulse widens in proportion to the APL stage as such, a pause period is prevented from increasing in the high APL stage and a sustain discharge is thus generated stably. In other words, if the Low width of the sustain pulse widens in proportion to the APL, the pause period where the sustain pulse is not supplied can be approximately kept constant regardless of the APL stage. If the pause period does not widen corresponding to the high APL stage as such, the sustain discharge can occur stably.

Meanwhile, in the present invention, as indicated by a dotted line of FIG. 7a, the APL stage can be divided into a number of sections and the Low width of the sustain pulse can be increased corresponding to the sections. In other words, in the present invention, as indicated by the dotted line of FIG. 7a, the APL stage can be divided into a number of the sections, sustain pulses having the same Low width can be supplied in an APL stage included in the same section, and sustain pulses having different Low widths can be supplied in an APL stage included in different sections. Moreover, in the present invention, it is possible to set the period of the sustain pulse wide by increasing the Low width and the High width of the sustain pulse as a low APL stage gradually changes to a high APL stage.

### Second Embodiment

According to the present invention, there is provided a method for driving a plasma display panel, including the steps of: setting the number of a sustain pulse corresponding to an average picture level (APL); and setting a High width of a sustain pulse in proportion to the average picture level.

The method step of setting the number of the sustain pulse includes setting the number of the sustain pulse in inverse proportion to the average picture level.

A Low width of the sustain pulse keeps a predetermined width regardless of the average picture level.

A maximum High width of the sustain pulse is set within a range of 0.5 μs to 10 μs wider than a minimum High width of the sustain pulse.

The step of setting the High width of the sustain pulse in proportion to the average picture level includes the steps of dividing the average picture level into a number of sections so that at least two average picture level step is included, and setting a High width of the sustain pulse using the average picture level section as a unit.

In at least some section of the average picture level, the High width of the sustain pulse is changed.

The method further includes the step of setting a minimum threshold frequency over a predetermined average picture level stage so that the High width of the sustain pulse is limited less than a predetermined width.

The minimum threshold frequency is set so that the greatest High width of a sustain pulse that can be supplied widens within a range of 0.5 μs to 10 μs from the smallest High width of the sustain pulse.

The method further includes the step of setting a maximum threshold frequency below a predetermined average picture level stage so that the High width of the sustain pulse is limited over a predetermined width.

The High width of the sustain pulse increases in a step shape as the period changes from a low stage of the average picture level to a high stage of the average picture level.

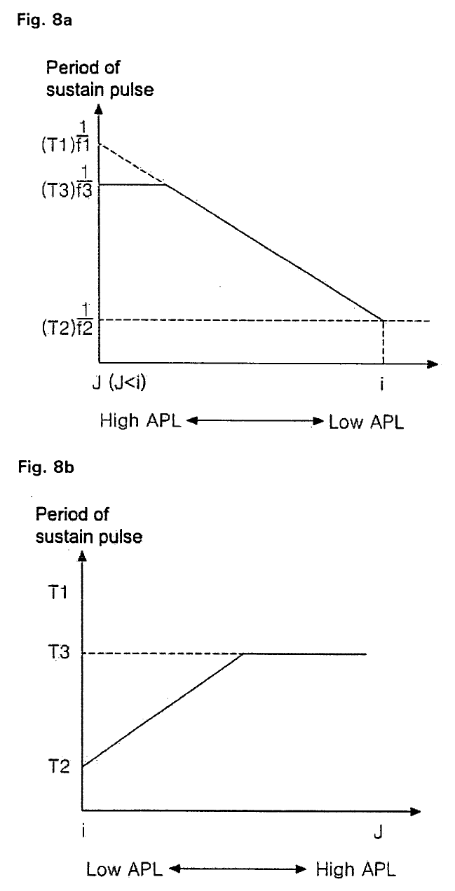

FIG. 8a and FIG. 8b are graphs illustrating the period of a sustain pulse depending on an APL according to a second embodiment of the present invention.

Referring to FIG. 8a and FIG. 8b, in the second embodiment of the present invention, the period of the sustain pulse increases linearly (a frequency reduces linearly) as a low APL stage changes to a high APL stage. Also, in the second embodiment of the present invention, a minimum threshold frequency f3 (i.e., a maximum sustain pulse period T3) is set. In this state, if the APL stage increases over a predetermined value, a sustain pulse having the minimum threshold frequency f3 is supplied to a panel.

This will be described in detail as follows. In the second embodiment of the present invention, the period of the sustain pulse is set in proportion to the APL stage. In other words, the sustain period can be utilized sufficiently even in the APL stage by increasing the period of the sustain together pulse when the APL stage increases.

Furthermore, in the second embodiment of the present invention, the minimum threshold frequency f3 is set so that the period of the sustain pulse is kept constant when the APL stage exceeds a specific stage. For example, if the minimum limit frequency f3 is set so that the sustain pulse has the period of 15 μs, the sustain pulse having the period of 15 μs is supplied in an APL stage of over a specific stage. In other words, in an APL stage of over a specific stage, only the number of a sustain pulse is changed (the higher the APL stage, the smaller the number of the sustain pulse, as shown in FIG. 4) but the period (or frequency) of the sustain pulse keeps constant. In the above, the minimum threshold frequency f3 can be set in advance by a designer so that a sufficient sustain margin is secured in a high APL stage. Practically, the minimum threshold frequency f3 can be set in various ways considering resolution, inch, etc. of a PDP so that the PDP can operate stably. For instance, if a sustain pulse having the period of 5 μs is supplied in the lowest APL stage, the minimum threshold frequency f3 can be set so that the period of a sustain pulse that can be supplied by maximum becomes 5.5 μs to 15 μs. In other words, in the second embodiment of the present invention, the threshold frequency f3 is set so that the period of the sustain pulse increases approximately 0.5 μs to 10 μs from the period of the sustain pulse supplied in the lowest APL stage.

In the second embodiment of the present invention, as such, since the period of the sustain pulse increases linearly in proportion to the APL stage, a pause period is prevented from widening in a high APL stage and a sustain driving margin can be thus improved. Furthermore, by setting the minimum threshold frequency f3 so that all the sustain pulses within a predetermined sustain period can be supplied, a stabilized sustain discharge can be generated.

### Third Embodiment

According to the present invention, there is provided a method for driving a plasma display panel, including the steps of: setting the number of a sustain pulse corresponding to an average picture level (APL); and setting a Low width of a sustain pulse in proportion to the average picture level.

The step of setting the number of the sustain pulse includes setting the number of the sustain pulse in inverse proportion to the average picture level.

A maximum Low width of the sustain pulse is set within a range of 0.5 μs to 10 μs wider than a minimum Low width of the sustain pulse.

The step of setting the Low width of the sustain pulse in proportion to the average picture level includes the steps of dividing the average picture level into a number of sections so that at least two average picture level step is included, and setting a Low width of the sustain pulse using the average picture level section as a unit.

In at least some section of the average picture level, the Low width of the sustain pulse is changed.

The method further includes the step of setting a minimum threshold frequency over a predetermined average picture level stage so that the Low width of the sustain pulse is limited less than a predetermined width.

The minimum threshold frequency is set so that the greatest Low width of a sustain pulse that can be supplied widens within a range of 0.5 μs to 10 μs from the smallest Low width of the sustain pulse.

The method further includes the step of setting a maximum threshold frequency below a predetermined average picture level stage so that the Low width of the sustain pulse is limited over a predetermined width.

The High width of the sustain pulse increases in a step shape as the period changes from a low stage of the average picture level to a high stage of the average picture level.

According to the present invention, there is provided an apparatus for driving a plasma display panel, including: an average brightness level unit for setting an average picture level corresponding to video data; and a period setting unit for setting the period of a sustain pulse in proportion to the average picture level set in the average brightness level unit.

The period setting unit sets a High width of the sustain pulse in proportion to the average picture level.

The period setting unit sets a Low width of the sustain pulse in proportion to the average picture level.

The period setting unit sets a Low width and a High width of the sustain pulse in proportion to the average picture level.

The apparatus further includes a limit value setting unit for setting at least one of a maximum limit value where the period of the sustain pulse can widen and a minimum limit value where the period of the sustain pulse can narrow.

The period setting unit controls the period of the sustain pulse using at least one of the maximum limit value and the minimum limit value.

According to the present invention, there is provided an apparatus for driving a plasma display panel, including: an average brightness level unit for setting an average picture level corresponding to video data; and a period setting unit for setting a High width of a sustain pulse in proportion to the average picture level set in the average brightness level unit.

The apparatus further includes a limit value setting unit for setting at least one of a maximum limit value where a High width of the sustain pulse can widen and a minimum limit value where a High width of the sustain pulse can narrow.

The period setting unit controls the High width of the sustain pulse using at least one of the maximum limit value and the minimum limit value.

According to the present invention, there is provided an apparatus for driving a plasma display panel, including: an average brightness level unit for setting an average picture level corresponding to video data; and a period setting unit for setting a Low width of a sustain pulse in proportion to the average picture level set in the average brightness level unit.

The apparatus further includes a limit value setting unit for setting at least one of a maximum limit value where a Low width of the sustain pulse can widen and a minimum limit value where a Low width of the sustain pulse can narrow.

The period setting unit controls the Low width of the sustain pulse using at least one of the maximum limit value and the minimum limit value.

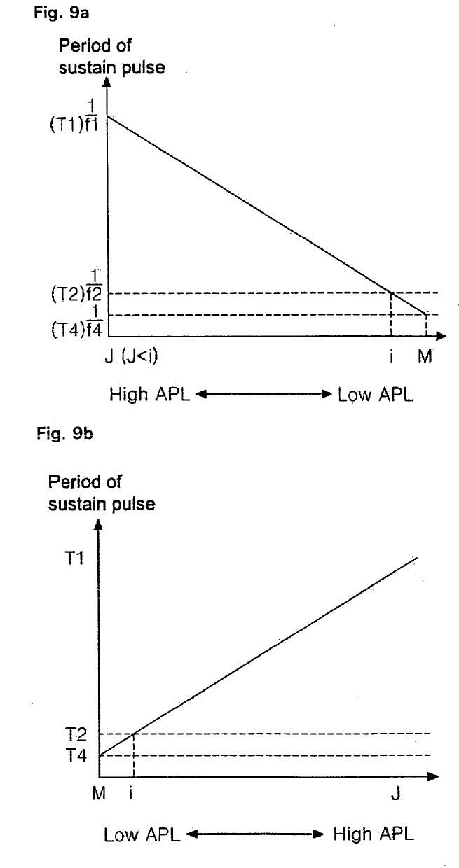

FIG. 9a and FIG. 9b are graphs showing the period of a sustain pulse depending on an APL according to a third embodiment of the present invention.

Referring to FIG. 9a and FIG. 9b, in the third embodiment of the present invention, the period of the sustain pulse increases linearly (a frequency reduces linearly) as a low APL stage gradually changes to a high APL stage. Furthermore, in the third embodiment of the present invention, it is possible to arbitrarily set the number of a sustain pulse applied to a panel in a low APL stage by setting a maximum threshold frequency f4 (i.e., a minimum sustain pulse period T4).

In other words, in the third embodiment of the present invention, the number of the sustain pulse that can be supplied to the panel in the lowest APL stage can be set arbitrarily by setting the maximum threshold frequency f4 at a predetermined location of an APL stage. For example, in the lowest APL stage, a maximum threshold frequency f4>f2 can be set so that an M (e.g. 1500) number of sustain pulses having a value greater than i (e.g. 1024) can be supplied to the panel. At this time, the period of the sustain pulse has a narrow period T4, for example, the period of 3 μs because it is in inverse proportion to the maximum threshold frequency. If the maximum threshold frequency f4 is set to be high and a large number of sustain pulses is thus supplied to the panel, peak brightness of the panel can be improved.

Meanwhile, in a high APL stage, a J (for example, 200) number of sustain pulses is supplied to the panel. At this time, a frequency f1 of the sustain pulse supplied in the high APL stage is set to have a low value. Accordingly, a period T1 of the sustain pulse having the inverse proportion relationship with the frequency f1 has a wide value, for example the period of 15 μs. In other words, in the high APL stage, a J number of a sustain pulse is supplied to the panel so that it has the period of T1.

As such, in the third embodiment of the present invention, it is possible to improve emission efficiency by linearly increasing the period of the sustain pulse in proportion to the APL stage. Furthermore, in the third embodiment of the present invention, a large number of sustain pulses is supplied in the low APL stage by setting the maximum threshold frequency f4 and peak brightness of a panel is thus increased.

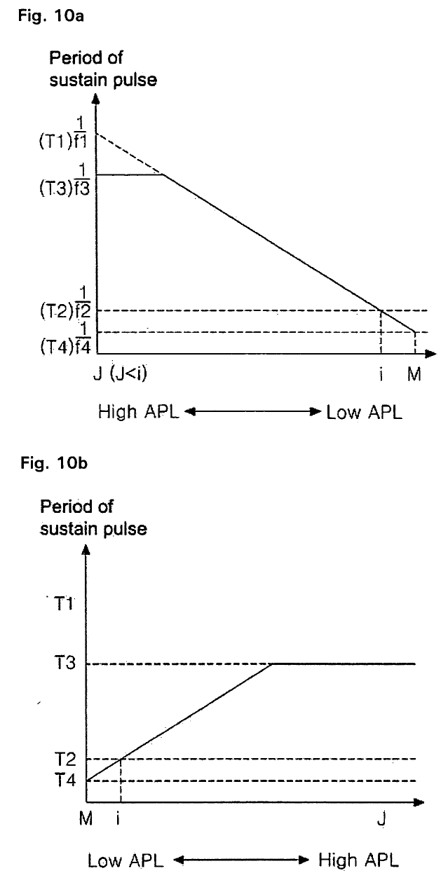

Meanwhile, in the present invention, as shown in FIG. 10a and FIG. 10b, the maximum threshold frequency f4 and the minimum threshold frequency f3 can be set at the same time. In other words, in the present invention, by setting the maximum threshold frequency f4 and the minimum threshold frequency f3 at the same time as in FIG. 8, peak brightness of the panel can be improved and a sustain discharge can be generated stably.

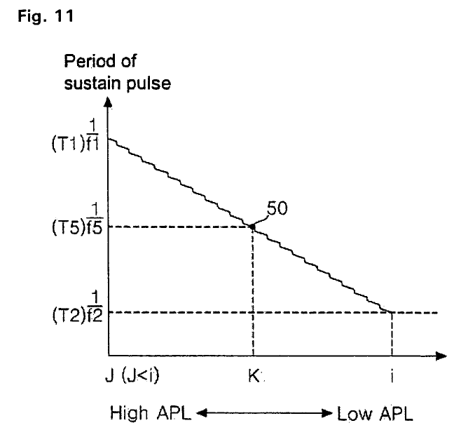

Meanwhile, in FIGS. 5a, 6a, 7a, 8a, 9a and 10a, it has been shown that the frequency (i.e., period) increases or decreases linearly depending on the APL stage. In the case where the present invention is applied to a PDP practically, however, the frequency (and the period) increases or decreases in a step shape depending on the APL stage, as shown in FIG. 11. This will be described in detail as follows. If the frequency increases or decreases linearly depending on the APL stage, it is required that a K number of a sustain pulse having the frequency of f5 (f2>f5>f1) be supplied in a predetermined step 50 of the APL. In the above, if the APL stage increased or decreases linearly, the frequency (or the period) of f5 can be set in a real number shape having a decimal point. As the frequency of a decimal point shape cannot be supplied, however, the frequency f5 is set in a fixed number shape using a descending mode. In other words, in the event that the present invention is applied practically, the frequency is set using a descending mode. Thus, the frequency (i.e., the period) increases or decreases in the step shape depending on the APL stage.

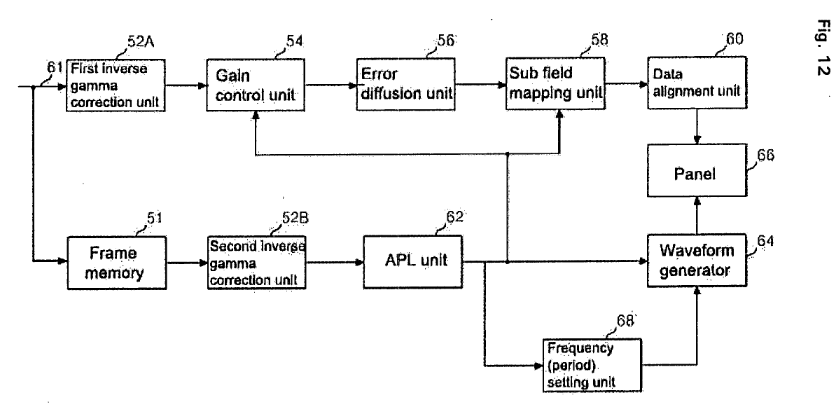

FIG. 12 is a block diagram illustrating the structure of an apparatus for driving a plasma display panel according to an embodiment of the present invention.

Referring to FIG. 12, the apparatus for driving the PDP according to an embodiment of the present invention includes a first inverse gamma correction unit 52A, a gain control unit 54, an error diffusion unit 56, a sub field mapping unit 58 and a data alignment unit 60 all of which are connected between an input line 61 and a panel 66; and a frame memory 51, a second inverse gamma correction unit 52B, an APL unit 62, a frequency (period) setting unit 68 and a waveform generator 64 all of which are connected between the input line 61 and the panel 66.

The first and second inverse gamma correction units 52A and 52B perform inverse gamma correction for a gamma-corrected video signal to linearly convert a brightness value depending on a gray level value of a picture signal. The frame memory 51 stores data R, G and B for one frame and supplies the stored data to the second inverse gamma correction unit 52B.

The APL unit 62 generates an N (N is a natural number) stage signal for controlling the number of a sustain pulse using the video data corrected by the second inverse gamma correction unit 52B. The gain control unit 54 amplifies the video data corrected in the first inverse gamma correction unit 52A as much as an effective gain.

The error diffusion unit 56 controls the brightness value minutely by diffusing an error component of a cell to neighboring cells. The sub field mapping unit 58 reallocates the video data corrected by the error diffusion unit 56 by the sub field.

The data alignment unit 60 converts the video data received from the sub field mapping unit 58 according to a resolution format of the panel 66 and supplies the converted video data to an address driving integrated circuit (hereinafter, referred to as “IC”) of the panel 66.

The frequency (period) setting unit 68 determines a frequency (period) of a sustain pulse depending on an APL stage supplied from the APL unit 62. For example, the frequency (period) setting unit 68 sets the period of the sustain pulse so that a sustain pulse having a wide period as the APL stage becomes high is supplied, as shown in FIG. 5a to FIG. 7b. In the above, the frequency (period) setting unit 68 widens the period of the sustain pulse by setting a High width and/or a Low width of the sustain pulse wide in proportion to the APL.

The waveform generator 64 generates a timing control signal according to the A stage signal received from the APL unit 62. At this time, the waveform generator 64 sets the frequency of the sustain pulse according to the frequency setting signal of the sustain pulse that is received from the frequency (period) setting unit 68. The timing control signal generated by the waveform generator 64 is supplied to the address driving IC, the scan driving IC and the sustain driving IC of the panel 66.

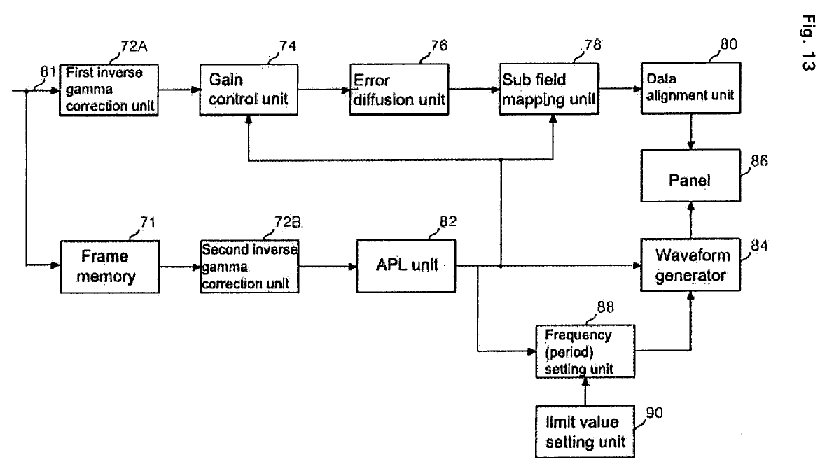

FIG. 13 is a block diagram illustrating the structure of an apparatus for driving a plasma display panel according to another embodiment of the present invention.

Referring to FIG. 13, the apparatus for driving the PDP according to another embodiment of the present invention includes a first inverse gamma correction unit 72A, a gain control unit 74, an error diffusion unit 76, a sub field mapping unit 78 and a data alignment unit 80 all of which are connected between an input line 81 and a panel 86; and a frame memory 71, a second inverse gamma correction unit 72B, an APL unit 72, a frequency (period) setting unit 78, a limit value setting unit 90 and a waveform generator 84 all of which are connected between the input line 81 and the panel 86.

The first and second inverse gamma correction units 72A and 72B perform inverse gamma correction for a gamma-corrected video signal to linearly convert a brightness value depending on a gray level value of a picture signal. The frame memory 71 stores data R, G and B for one frame and supplies the stored data to the second inverse gamma correction unit 72B.

The APL unit 82 generates an N (N is a natural number) stage signal for controlling the number of a sustain pulse using the video data corrected by the second inverse gamma correction unit 72B. The gain control unit 74 amplifies the video data corrected in the first inverse gamma correction unit 72A as much as an effective gain.

The error diffusion unit 76 controls the brightness value minutely by diffusing an error component of a cell to neighboring cells. The sub field mapping unit 78 reallocates the video data corrected by the error diffusion unit 76 by the sub field.

The data alignment unit 80 converts the video data received from the sub field mapping unit 78 according to the resolution format of the panel 86 and supplies the converted video data to an address driving IC of the panel 86.

The limit value setting unit 90 supplies a maximum limit value and/or a minimum limit value set in the frequency (period) setting unit 88 to the frequency (period) setting unit 88.

The frequency (period) setting unit 88 determines the frequency period of the sustain pulse corresponding to the APL stage supplied from the APL unit 82. For example, the frequency (period) setting unit 88 sets the period of the sustain pulse so that a sustain pulse having a wide period as the APL stage becomes high is supplied, as shown in FIG. 5a to FIG. 7b. In the above, the frequency (period) setting unit 88 widens the period of the sustain pulse by setting a High width and/or a Low width of the sustain pulse wide in proportion to the APL. The frequency (period) setting unit 88 sets the frequency (period) of the sustain pulse using the maximum limit value and/or the minimum limit value received from the limit value setting unit 90, as shown in FIG. 8a to FIG. 10b.

The waveform generator 84 generates a timing control signal according to the A stage signal received from the APL unit 82. At this time, the waveform generator 84 sets the frequency of the sustain pulse according to the frequency setting signal of the sustain pulse that is received from the frequency (period) setting unit 88. The timing control signal generated by the waveform generator 84 is supplied to the address driving IC, the scan driving IC and the sustain driving IC of the panel 86.

According to a method for driving a plasma display panel and apparatus thereof of the present invention, emission efficiency can be improved by supplying a sustain pulse that has a wide period as an APL stage becomes high. Furthermore, in the present invention, a large number of sustain pulses can be supplied in a low APL stage by setting a high minimum threshold frequency. Therefore, peak brightness of a panel can be improved. In addition, in the present invention, a stabilized sustain discharge can be generated by setting a maximum threshold frequency so that a constant sustain margin can be secured.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method for driving a plasma display panel, comprising the steps of:
setting the number of a sustain pulse corresponding to an average picture level (APL); and
setting the period of a sustain pulse in proportion to the average picture level.

2. The method as claimed in claim 1, wherein the step of setting the number of the sustain pulse includes setting the number of the sustain pulse in inverse proportion to the average picture level.

3. The method as claimed in claim 1, wherein the step of setting the period of the sustain pulse comprises the step of setting a High width of the sustain pulse wide in proportion to the average picture level.

4. The method as claimed in claim 1, wherein the step of setting the period of the sustain pulse comprises the step of setting a Low width of the sustain pulse wide in proportion to the average picture level.

5. The method as claimed in claim 1, wherein the step of setting the period of the sustain pulse comprises the step of setting a Low width and a High width of the sustain pulse wide in proportion to the average picture level.

6. The method as claimed in claim 1, wherein the greatest period of the sustain pulse is set 0.5 μs to 10 μs higher than the smallest period of the sustain pulse.

7. The method as claimed in claim 1, wherein in at least some section of the average picture level, the period of the sustain pulse is changed.

8. The method as claimed in claim 7, further comprising the step of setting a minimum threshold frequency over a predetermined average picture level stage so that the period of the sustain pulse is limited less than a predetermined width.

9. The method as claimed in claim 8, wherein the minimum threshold frequency is set so that the greatest period of a sustain pulse that can be supplied widens within a range of 0.5 μs to 10 μs from the smallest period of the sustain pulse.

10. The method as claimed in claim 7, further comprising the step of setting a maximum threshold frequency below a predetermined average picture level stage so that the period of the sustain pulse is limited over a predetermined width.

11. The method as claimed in claim 1, wherein the period of the sustain pulse increases in a step shape as the period changes from a low stage of the average picture level to a high stage of the average picture level.

12. A method for driving a plasma display panel, comprising the steps of:
setting the number of a sustain pulse corresponding to an average picture level (APL); and
setting a High width of a sustain pulse in proportion to the average picture level.

13. The method as claimed in claim 12, wherein the step of setting the number of the sustain pulse includes setting the number of the sustain pulse in inverse proportion to the average picture level.

14. The method as claimed in claim 12, wherein a Low width of the sustain pulse keeps a predetermined width regardless of the average picture level.

15. The method as claimed in claim 12, wherein a maximum High width of the sustain pulse is set within a range of 0.5 μs to 10 μs wider than a minimum High width of the sustain pulse.

16. The method as claimed in claim 12, wherein the step of setting the High width of the sustain pulse in proportion to the average picture level comprises the steps of:
dividing the average picture level into a number of sections so that at least two average picture level step is included; and
setting a High width of the sustain pulse using the average picture level section as a unit.

17. The method as claimed in claim 12, wherein in at least some section of the average picture level, the High width of the sustain pulse is changed.

18. The method as claimed in claim 17, further comprising the step of setting a minimum threshold frequency over a predetermined average picture level stage so that the High width of the sustain pulse is limited less than a predetermined width.

19. The method as claimed in claim 18, wherein the minimum threshold frequency is set so that the greatest High width of a sustain pulse that can be supplied widens within a range of 0.5 μs to 10 μs from the smallest High width of the sustain pulse.

20. The method as claimed in claim 17, further comprising the step of setting a maximum threshold frequency below a predetermined average picture level stage so that the High width of the sustain pulse is limited over a predetermined width.

21. The method as claimed in claim 12, wherein the High width of the sustain pulse increases in a step shape as the period changes from a low stage of the average picture level to a high stage of the average picture level.

22. A method for driving a plasma display panel, comprising the steps of:
setting the number of a sustain pulse corresponding to an average picture level (APL); and
setting a Low width of a sustain pulse in proportion to the average picture level.

23. The method as claimed in claim 22, wherein the step of setting the number of the sustain pulse includes setting the number of the sustain pulse in inverse proportion to the average picture level.

24. The method as claimed in claim 22, wherein a maximum Low width of the sustain pulse is set within a range of 0.5 μs to 10 μs wider than a minimum Low width of the sustain pulse.

25. The method as claimed in claim 22, wherein the step of setting the Low width of the sustain pulse in proportion to the average picture level comprises the steps of:
dividing the average picture level into a number of sections so that at least two average picture level step is included; and
setting a Low width of the sustain pulse using the average picture level section as a unit.

26. The method as claimed in claim 22, wherein in at least some section of the average picture level, the Low width of the sustain pulse is changed.

27. The method as claimed in claim 26, further comprising the step of setting a minimum threshold frequency over a predetermined average picture level stage so that the Low width of the sustain pulse is limited less than a predetermined width.

28. The method as claimed in claim 27, wherein the minimum threshold frequency is set so that the greatest Low width of a sustain pulse that can be supplied widens within a range of 0.5 μs to 10 μs from the smallest Low width of the sustain pulse.

29. The method as claimed in claim 26, further comprising the step of setting a maximum threshold frequency below a predetermined average picture level stage so that the Low width of the sustain pulse is limited over a predetermined width.

30. The method as claimed in claim 22, wherein the High width of the sustain pulse increases in a step shape as the period changes from a low stage of the average picture level to a high stage of the average picture level.

31. An apparatus for driving a plasma display panel, comprising:
an average brightness level unit for setting an average picture level corresponding to video data; and
a period setting unit for setting the period of a sustain pulse in proportion to the average picture level set in the average brightness level unit.

32. The apparatus as claimed in claim 31, wherein the period setting unit sets a High width of the sustain pulse in proportion to the average picture level.

33. The apparatus as claimed in claim 31, wherein the period setting unit sets a Low width of the sustain pulse in proportion to the average picture level.

34. The apparatus as claimed in claim 31, wherein the period setting unit sets a Low width and a High width of the sustain pulse in proportion to the average picture level.

35. The apparatus as claimed in claim 35, further comprising a limit value setting unit for setting at least one of a maximum limit value where the period of the sustain pulse can widen and a minimum limit value where the period of the sustain pulse can narrow.

36. The apparatus as claimed in claim 35, wherein the period setting unit controls the period of the sustain pulse using at least one of the maximum limit value and the minimum limit value.

37. An apparatus for driving a plasma display panel, comprising:
an average brightness level unit for setting an average picture level corresponding to video data; and
a period setting unit for setting a High width of a sustain pulse in proportion to the average picture level set in the average brightness level unit.

38. The apparatus as claimed in claim 37, further comprising a limit value setting unit for setting at least one of a maximum limit value where a High width of the sustain pulse can widen and a minimum limit value where a High width of the sustain pulse can narrow.

39. The apparatus as claimed in claim 38, wherein the period setting unit controls the High width of the sustain pulse using at least one of the maximum limit value and the minimum limit value.

40. An apparatus for driving a plasma display panel, comprising:
an average brightness level unit for setting an average picture level corresponding to video data; and
a period setting unit for setting a Low width of a sustain pulse in proportion to the average picture level set in the average brightness level unit.

41. The apparatus as claimed in claim 40, further comprising a limit value setting unit for setting at least one of a maximum limit value where a Low width of the sustain pulse can widen and a minimum limit value where a Low width of the sustain pulse can narrow.

42. The apparatus as claimed in claim 41, wherein the period setting unit controls the Low width of the sustain pulse using at least one of the maximum limit value and the minimum limit value.
